(19) United States
(12) Patent Application Publication
(10) Pub. No.: US 2005/0083862 A1
(43) Pub. Date: Apr. 21, 2005

(54) Data migration method, system and node

(76) Inventor: George Philip Kongalath, St-Laurent (CA)

Correspondence Address: ALEX NICOLAESCU;Ericsson Canada Inc., Patent Department (LMC/M/P), 8400 Decarie Blvd., Town Mount Royal, QC, H4P 2N2, CA

(21) Appl. No.: 10/687,654

(22) Filed: Oct. 20, 2003

(51) Int. Cl. H04L 5/22

(52) U.S. Cl. 370/299

(57) ABSTRACT

A method, system and node for migrating data from a source to a target node without interrupting service provisioning, wherein the target node becomes responsible for receiving, processing, and responding to service requests. During migration, a service request from an application is received and the target node determines if the data required for processing the request has been already. If not, the target node forwards the request to the source node, and receives back a result, which it uses to respond to the application. The target node may use the result to populate its database. In another variant, once a certain portion of data is transferred to the target node, the later receives a new service request for that portion of data, both the source and the target node process the new request, and the results are compared to determine if the transfer to the target node was successful.

### BACKGROUND OF THE INVENTION

1. Field of the Invention

The present invention relates to the field of data migration from one or more source data servicing nodes to another target data servicing node.

2. Description of the Related Art

In the computer-related field, data sometimes need to be migrated from one database to another database. Occasionally, this also require converting the migrated data into a common format that can be output from the old database and input into the new database. Since the new database may be organized differently, it may be necessary to use a translation program that can process the migrating data. Migration is also used to refer simply to the process of moving data from one storage device to another, without conversion.

For example, in the cellular field, a Home Location Register (HLR) is the main database of a mobile network that stores information for each cellular subscriber. The HLR is an integral component of a cellular network and is maintained by the subscriber's home network operator where the user initiated the call. The HLR contains pertinent user information, including identity indexes, address, account status, and service preferences. The HLR interacts with the mobile switch of the cellular network that is used for call control and processing, which also serves as a point-of-access to the Public Switched Telephone Network (PSTN—the fixed network). When a user initiates a call, the switching equipment determines whether the call is coming from the device's home area. If the user is out of the home area, a request for information required to process the call is issued. The switching node queries the HLR identified by the call for information, which returns to the appropriate MSC subscriber-related information allowing the call to prodeed.

Therefore, it is of utmost importance that the HLR be always available to provide location information so that mobile stations of a cellular network can be reached for a call. For example, an unavailable HLR translates into a downtime for the entire cellular network, which may oftentimes include millions of subscribers.

However, instances arise when the data of an HLR must be migrated into a new HLR. This may be required due to capacity limitations of the old HLR, deficiencies of the old HLR, operator migration, etc. Due to the service availability requirements, telecom operators have a difficult time when migrating data from an old node to a new one. The problem is further compounded when the target node for the migration belongs to a different vendor.

In the past, the maintenance windows allowed for a data migration of data from an old HLR into a new HLR, during which the service provisioning was allowed to be stopped, were in the 6-7 hours range, and the number of subscriber records to be transferred was relatively small, typically in the range of 300,000 to 500,000. However, in recent days, the maintenance window imposed by network operators has shrunk to around 3 hours and the number of subscribers to be migrated has quadrupled to 1.5-2 millions. This is due to the network operators' desire to minimise the downtime of their system so that subscribers receive almost uninterrupted mobile service.

When a data migration also involves data translation from the data format of the old node to the data format of the new node, the process takes even longer and even with today's higher capacity processing engines, restructuring data and “pumping “it into the new node is time consuming. While the data translation is taking place, all service provisioning based on the data being transferred has to be frozen and customers features updates have to be processed in another, subsequent process.

To complicate matters even further, inter-vendor migration involves numerous problems associated with data deciphering as each vendor may maintain at least a portion of its reference data encrypted. As an end-result, telecom operators have a considerable problem in migrating data from one node to another.

One of the solutions used today for migration is to get a “dump” of the data from the source node. Depending on the number of subscribers and the system this could take several hours. Once the dump is ready, it has to be “pumped in” or provisioned into the target node. Most systems on the market have a low capacity in the normal provisioning process and only a few systems have a mechanism for fast data uploading. The best-known fast load is in the range of 600,000 subscriber records per hour, which barely makes the maintenance window. After pumping, all traffic transactions are re-routed to the new node. Meanwhile, the above process has to be repeated on the old node to capture the entire subscriber initiated feature updates that occurred on the old node during the initial migration, which is herein referred as the delta dump. Generally, it is not always feasible to identify and generate a delta dump, and therefore the entire process is most often repeated and the delta dump calculated by a translation software.

Another known solution for data migration is shown in FIG. 1 (Prior Art), which is a nodal operation and signal flow diagram of a network 100 implementing a data migration mechanism. The network 100 has two nodes, shown as Node A 102 and Node B 104. Responsive to a migration request 106, the source data of Node A 102 is frozen, action 108, and possibly translated, action 110, into a format suitable for the target Node B 104. The data transfer from Node A 102 to Node B 104 is started at step 112, as the database of the target Node 104 is frozen as well for receiving the incoming data, action 113. Portions of data (e.g. subscriber records) are subsequently and consecutively sent, actions 114i, from Node A 102 to Node B 104. Meanwhile, each service request 116 that may come from an external application 117 (e.g. switching node) is provided no response or an error response 118 by the frozen Node B 104, until the time the transfer is completed and the service of Node B is re-established, action 120.

The difficulty with the existing solutions is that there are finite volumes of data, or subscriber records in the case of an HLR, that can be transferred from one node to another during a maintenance window. Even with increasing processing power of newer computer systems, a limit will always exist and no system will ever be able to keep up with the increasing data transfer demands during a finite maintenance window.

Although there is no prior art solution as the one proposed hereinafter for solving the above-mentioned deficiencies, the US patent application publication US2003/0069903 to Gupta et al., herein called Gupta, bears some relation with the field of the present invention. Gupta teaches a database migration system and method for providing almost continuous transaction service during a data migration that minimises transaction service downtime. In Gupta, the active database (source) is copied to a target database and updated at least one time. Updating occurs over decreasing time intervals. When the time intervals become sufficiently short, transition to the target server is implemented by queuing transaction requests from the source server and executing them on the target server. Although Gupta minimises the service interruption, Gupta fails to teach a system wherein the service provision is completely uninterrupted.

The commonly owned U.S. Pat. No. 6,115,463 issued to Coulombe et al. also bears some relation to the field of the present invention. Coulombe teaches a data migration mechanism between two HLRs of a public telecommunications system, wherein a data administrator selects the most appropriate telecommunication means over which reference data is to be migrated from the first HLR to the second HLR. Before communication, the first HLR verifies a common channel signalling system functionality level of the second HLR, and if verified, the communication is sent unformatted and stored in the target HLR. Alternatively, a data network and service management access layer further interconnects two HLRs. The data administrator responds to a migration request by generating HLR specific commands instructing the first HLR to extract subscriber data for transfer over a data network and to the service management access layer the second HLR. Transfer considerations are also evaluated to select either the common channel signalling or the data network as a means for data migration. Therefore, Coulombe deals with an optimized selection of transfer means from the first to the second HLR, and fails to address the issue, or provide a solution for uninterrupted data provisioning service.

Accordingly, it should be readily appreciated that in order to overcome the deficiencies and shortcomings of the existing solutions, it would be advantageous to have a mechanism for reliable data transfer between nodes that does not have a finite time requirement while not affecting data availability. If would be of even greater advantage if such a mechanism could avoid the insertion of new nodes' identities in the network, since this is difficult to achieve in some systems, such as for example in telecom networks. Finally, it would be advantageous to have a migration mechanism that includes all data provisioning and subscriber initiated updates that occur during the data migration process. The present invention provides such a mechanism.

### SUMMARY OF THE INVENTION

In one aspect, the present invention is a method for migrating reference data from a source node to a target node, the method comprising the steps of:
a) during a data migration from the source node to the target node, receiving a service request at the target node;
b) determining at the target node if the reference data necessary to process the service request has been already migrated from the source node to the target node;
c) if the reference data necessary to process the service request has not been already migrated from the source node to the target node, forwarding the service request from the target node to the source node;
d) receiving at the target node a result of a processing of the service request from the source node; and
e) responding by the target node to the service request with a service request response based on the result received from the source node.

In another aspect, the present invention is a system comprising:
a source node from which reference data is to be migrated;
a target node to whom the reference data is to be migrated; and
an external application;
wherein a service request originated from the external application is received at the target node during migration of the data from the source to the target node and responsive to the service request, the target node determines if the reference data necessary to process the service request has been already migrated from the source to −6the target node, and if not, the target node forwards the service request to the source node, which processes the service request and returns to the target node a result of the processing, and the target node responds to the external application with a service request response based on the result received from the source node.

In yet another aspect, the invention is a target node to whom the reference data is to be migrated from a source node, which receives a service request originated from an external application during a process of data migration from the source to the target node and, responsive to a receipt of the service request, the target node acts to determine if the reference data necessary to process the service request has been already received from the source and if not, the target node acts to forward the service request to the source node, and in turn receives a result of the processing of the new service request by the source node, and responds to the external application with a service request response based on the result received from the source node.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level nodal operation and signal flow diagram illustrative of a prior art mechanism for data migration;

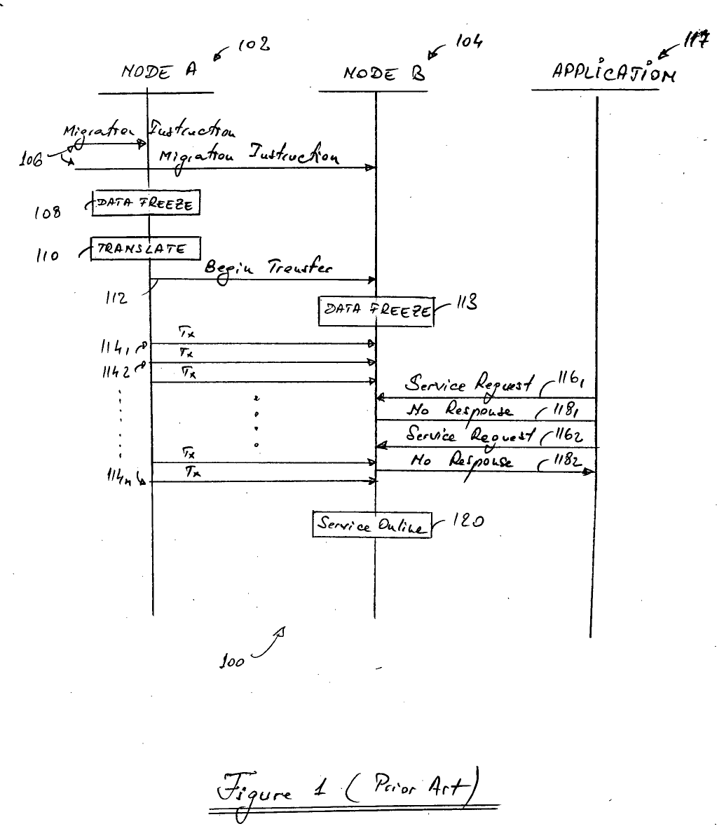

FIG. 2 is a high-level nodal operation and signal flow diagram illustrative of the preferred embodiment of the invention;

FIG. 3 is another high-level nodal operation and signal flow diagram illustrative of a variant of the preferred embodiment of the invention; and

FIG. 4 is yet another high-level nodal operation and signal flow diagram illustrative of another variant of the preferred embodiment of the invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method, system, and node allowing for the reliable migration of data from one or more source data servicing nodes to one target data servicing node, without any service provisioning interruption, and without imposing a time limitation for the transfer to be completed.

According to the preferred embodiment of the present invention first, a data migration process is initiated, and portions of data begin to be transferred from one or more source data servicing nodes to a target data servicing node. As the data transfer is commenced, the target node is tagged as the new master node which is entitled to receive and process all incoming data service transactions or requests, while the source node becomes a slave node of the target. When a new data servicing request is received at the master data servicing node (the target node), the later first determines whether the data portion (e.g. a data record associated with a mobile subscriber) required to process the incoming request has been already transferred from the source node. If so, the request is processed solely by the target data servicing node and a request response is issued to the requesting application. Otherwise, if the data portion required to process the incoming request is not found at the target node, it is deduced that the data of interest has not been yet transferred from the source data servicing node, and the service request is forwarded to the source data servicing node (the slave node). The later processes the request, and returns a request response to the master node, which relays the response to the requesting application. The request response received at the target node may also be stored so that when migrating the record in question that record can be inspected and data changes can be appended, if required. At some point in time, all data transfer is completed toward the target data servicing node, so that the source and the target nodes can be disconnected.

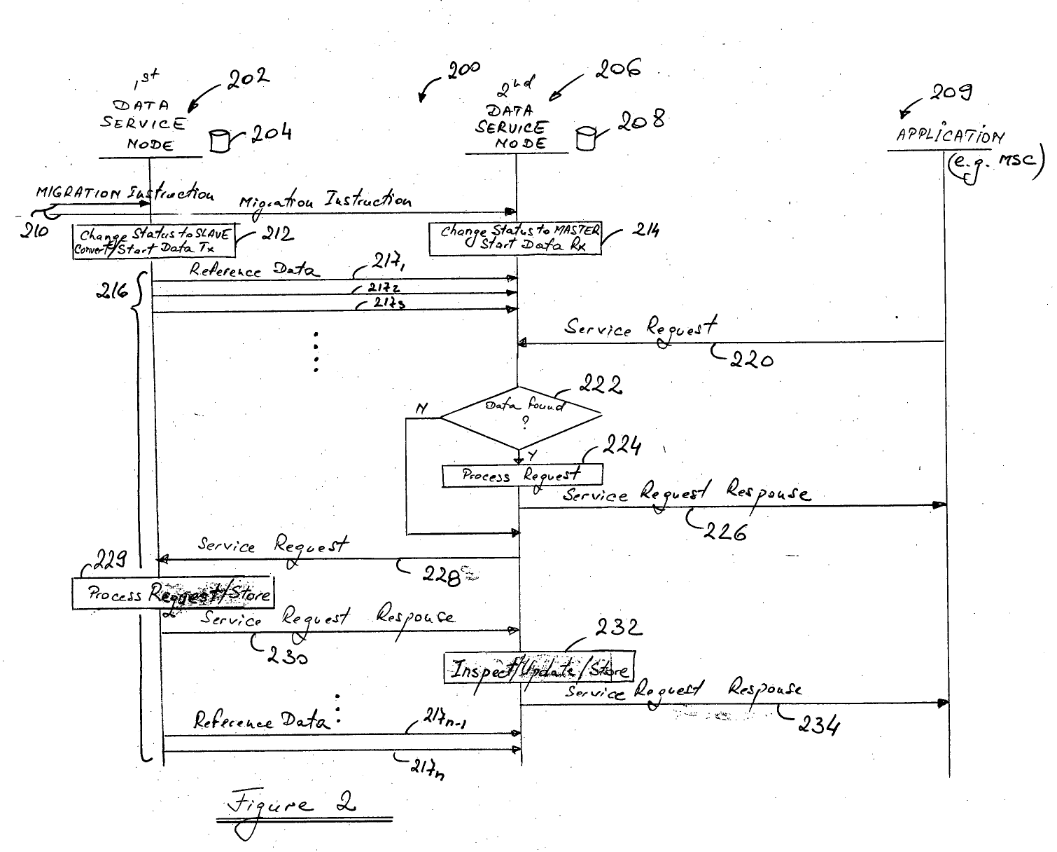

Reference is now made to FIG. 2, which is a nodal operation and signal flow diagram of a data network 200 implementing the preferred embodiment of the present invention. Illustrated in FIG. 2 is a source data servicing node 202 comprising a data repository, such as for example a database 204 for storing reference data used for providing one or more services. For example, the node 202 may be an HLR of a mobile network and the reference data may comprise subscriber records storing subscriber profile, location information, and billing data associated with subscribers of the mobile network. Also shown in FIG. 2, is a target data servicing node 206 which may have a similar configuration and function as node 202, including a similar database 208, with the exception that the database 208 of the target node 206 is not yet populated with data. It is further assumed that reference data of the source node 202 must be migrated to node 206.

At step 210, a migration instruction is sent to both the source and the target data servicing nodes 202 and 206. Node 202 responds to the migration request by setting its status to slave node, and by starting the reference data migration process, action 212. In case the data format of the database 204 of the source node 206 differs from the data format of the database 208 of the target node 206, action 212 may also comprise converting the reference data of database 204 from a first data format associated with the database 204 to a second format understood and associated with the database 208 of the target data servicing node 206. Responsive to instruction 210, the target node 206 changes its status to master node, action 214, i.e. a node that is entitled to receive, process and respond to external requests form different applications, like application 209. For example, if the node 206 is an HLR, requests for subscriber-related information may originate from a Mobile Switching Center (MSC) of the mobile network and be received by node 206.

As the data migration process 216 is commenced and individual portions of data 217i are transmitted from the source data servicing node 202 to the target data servicing node 206, a service request 220 issued by the application 209 may be received by the target node (the master node) during the migration process. As the migration process is still uncompleted, the target node 206 first determines if the data required to process and respond to the request 220 has been already transferred from the source node 202, action 222, and if so, in action 224 processes the request 220, and responds to the application 209 by transmitting a service request response 226.

Alternatively, if in action 222 it is determined by the target node 206 that the data required for processing the request 220 has not been yet received, the service request 220 is forwarded, action 228, to the source data servicing node 202, which still stores the data required to process the request 220. In action 229, the source node processes the request 228 and possibly also stores the result of the processing. The source node 222 further returns to the target node 206 a service request response 230 with the result of the processing 229. In action 232, the target node 206 may inspect the result received in the response 230, may update the response as necessary, and may store the reference data modified by the response 230 as necessary for the particular implementation. Finally, the target node 206 sends a service request response 234 to the requesting application 209 with the result of the processing 229.

At some point, the reference data migration process 216 is terminated, and the connection between the source node 202 and the target node 206 may be interrupted (action not shown).

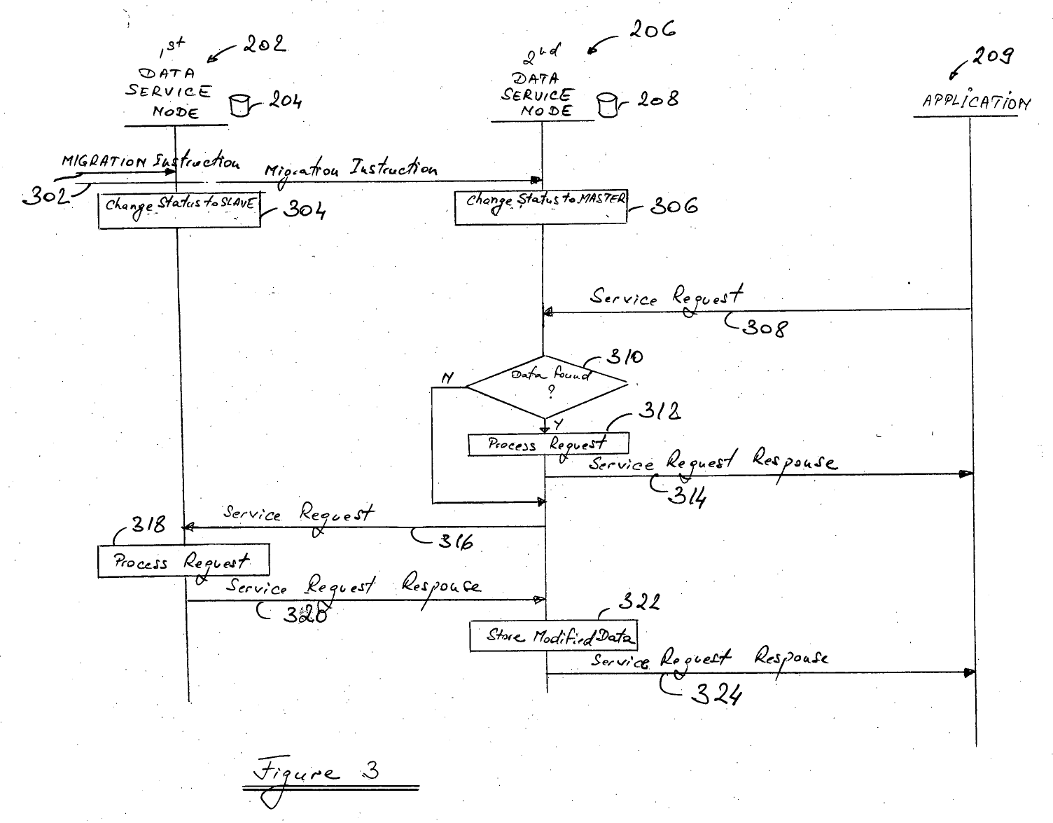

Reference is now made to FIG. 3, which is a nodal operation and signal flow diagram of a data network 300 implementing a variant of the preferred embodiment of the present invention. According to the present variant of the preferred embodiment of the invention, a punctual data reference migration process is started on nodes similar to the ones previously described with reference to FIG. 2, wherein a particular data portion of the reference data stored in the source node 202 (e.g. a particular subscriber record) is migrated to the target data servicing node 206 each time a new service request is received by the target node 206, wherein the processing of the service request necessitates that particular portion of the reference data. In some instances, depending on the type of the service request transaction, it may require multiple transactions to transfer an entire set of data, such as for example an entire subscriber record of and HLR. For example, in a mobile network, a REGNOT transaction request addressed to an HLR 206 will trigger the transfer of the entire subscriber profile, whereas a FEATREQ will only trigger the transfer of partial data related to a specific feature of the subscriber profile.

With reference to FIG. 3, the process starts in action 302 when a migration instruction is issued for both the source data servicing node 202 and the target data servicing node 206. Responsive to the instruction 302, the source node 202 status is changed to slave, as described hereinbefore, action 304, while the target node 306 status is changed to master node, action 306, for receiving, processing and responding to service requests and transactions originated by external applications alike the application 209, thus creating a master-slave relation between nodes 202 and 206. The status change of actions 304 and 306 represents the beginning of the migration process of reference data from the source node 202 to the target node 206. This variant of the preferred embodiment of the invention is of particular interest in situations where it is difficult to obtain a full data dump for translation and migration. Such difficulty may be caused, for example, by the unavailability of data translation tables, by slow output of data, or by protected/encrypted data.

At some point in time, the target node 206 receives a new service request 308 for a certain service. Responsive to the request 308, the target node 206 may optionally first determine if the data required for processing and responding to the request has been already migrated from the source node 202, action 310. If so, the target node may process the request 308 locally, action 312, and respond to the request 308 with a service request response message 314 transmitted to the requesting application 209. Otherwise, in case the data required for processing and responding to the request 308 has not been transferred to the target node 206, the later transmits a service request 316, corresponding to the original service request 308, to the source node 202. The later receives the service request 316, processes the request in action 318, and responds to the target node 206 with a service request response 320. In action 322, the target node 206 stores the data modified by the processing 318, and responds to the requesting application with a service request response message 324.

According to the present variant of the preferred embodiment of the invention, a portion of the reference data of the source node 202 is migrated to the target node 206 each time a request 308 is received and the data required for processing the request has not been already transferred to the target node, by sendirig from the source node 202 to that target node 206 the service request response 320, which is used by the target node to populate its database 208. As service requests continue to be received by the target node 206, and as these requests involve various portions of the reference data stored in the database 204 of the source node 202, the process shown in FIG. 3 is repeated each time i) such new request is received and ii) the potion of data required to process such request is determined to not be already transferred to the target node 206, and data from the source node is transferred as shown, for each such request, to the database 208 of the target node 206. At some point in time, for example one week or one month later, all or almost all data of the source node 202 is transferred to the target node 206. Small residual data of source node 202 that is not transferred to the target node 206 even after that period of time, because no service request involving that data was received at the target node 206 during the same period, may be manually transferred to the target node with a special migration instruction (not shown).

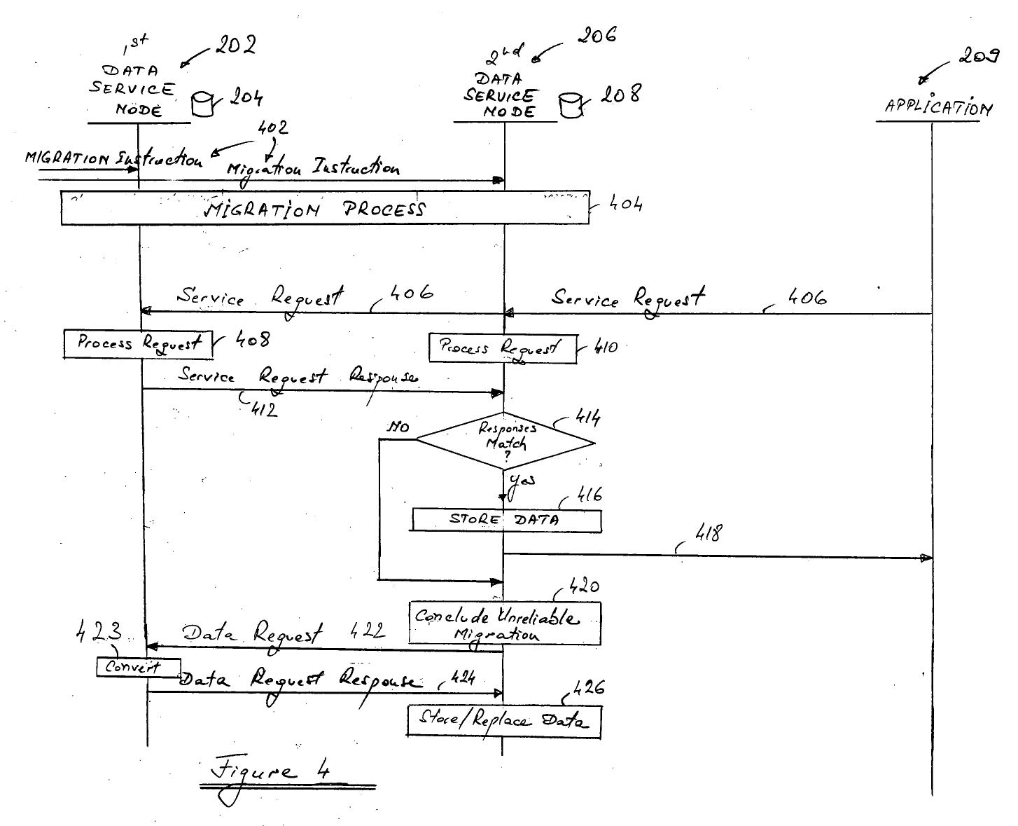

Reference is now made to FIG. 4, which is another nodal operation and signal flow diagram of an exemplary network 200 implementing yet another variant of the present invention. Shown in FIG. 4 are nodes 202, 206, and 209 similar to the ones already described beforehand with reference to FIGS. 2 and 3. According to the present variant of the invention, once the migration process of the reference data is completed, or completed for at least a portion of the reference data, a migration reliability verification is performed before responding to a given service request from an external application, like application 209. The purpose of the migration reliability verification is to determine whether the migration of data from the source to the target node has been accurately completed, i.e. the data has been accurately copied and translated to the target node. This is achieved by processing a given service request on both the target and the source nodes, and by comparing data processing responses from the source node with data processing responses from the target node. In case the responses match, it is concluded that the transfer of the portion of the reference data used for the processing has been completed successfully, since it is the only possibility for the response match, while otherwise, if a data processing response issued by the target node does not match a data processing response issued by the source node, it is concluded that the data migration of that particular portion of data from the source to the target node was erroneous and that the migrated data differs form the source data.

With reference to FIG. 4, the present variant of the invention starts with action 402, wherein a migration instruction is received by the source node 202 and by the target node 206. In action 404, the migration process is at least started, and possibly completed. It is to be noted that the suite of actions of FIG. 4 may also be performed during a data migration that is not yet fully completed.

At one point in time, a new service request 406 is issued by an external application 209, and received by the target node 206, which acts as the master node for receiving, processing and responding to external applications' requests and transactions, as described hereinbefore. The new service request 406 is also forwarded to the source node 202, which acts as a slave node to the target node 206, as described beforehand. This forwarding allows for the service request to be processed in parallel, although independently, by each one of the source node 202 and the target node 206, based on data stored locally on the respective internal databases 204 and 208, actions 408 and 410 respectively. In action 412, the source node 202 returns a service request response with a result of the processing 408, and in action 414, the target node 206 determines whether the result received in action 412 from the source node 202 matches its own result calculated in action 410. In the affirmative, the result is stored locally in the database 208 of the target node 206, action 416, and a service request response is returned to the requesting application 209, action 418. Otherwise, if the responses issued by the source node 202 in action 408 and the target node 206 in action 410 do not match, it is concluded in action 420 that the migration of the portion of data required to process the service request 406 in actions 408 and 410 has not been completed accurately, and that this portion of data stored in the target service node 206 is unreliable. In such case, the target node 206 may issue a data request message 422 requesting a re-sending of that portion of data from the source node 202, which responds to the target node 206 with the transmitting of the requested data, action 424. Action 423 may be needed to convert the required data from a first format associated with the database 204 of the source node 202 to a second format associated with the database 208 of the target node 206. Finally, the target node 206 stores the received reference data in its local database 208, action 426, by replacing the erroneous portion of data.

Therefore, with the present invention it becomes possible to migrate large portions of data from source data servicing nodes to a target data servicing node, without being limited by time constraints. The invention allows this by providing continuous service provisioning during the process of data migration. Moreover, the invention not only allows for uninterrupted data service provisioning during a data migration from one node to another, but also provides a verification of the reliability of the data migration, as described hereinbefore.

It is also to be noted that although the preferred embodiment of the invention has been described with reference to only one source data servicing node, the invention is also applicable to a data migration process involving data transfer from a plurality of source data servicing nodes into one target data servicing node. In such a case, the target node acts as the master node during the migration, and the source nodes become slave nodes with respect to the target node, and are individually contacted by the target node via service requests 228, 316, 408, and 422 as described hereinbefore with reference to FIGS. 2, 3 and 4.

Based upon the foregoing, it should now be apparent to those of ordinary skills in the art that the present invention provides an advantageous solution for data migration with uninterrupted data provisioning service. Although the system and method of the present invention have been described with reference being made to a source and a target data servicing node, it should be realized upon reference hereto that the innovative teachings contained herein may be implemented advantageously with any type of nodes, including but being not limited to: an HLR of a mobile network, a Visitor Location Register (VLR) of a mobile network, any type of subscriber database of a telecommunications network, or any other type of node comprising reference data that may need to be migrated to a target location or node. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for migrating reference data from a source node to a target node, the method comprising the steps of:
a) during a data migration from the source node to the target node, receiving a service request at the target node;
b) determining at the target node if the reference data necessary to process the service request has been already migrated from the source node to the target node;
c) if the reference data necessary to process the service request has not been already migrated from the source node to the target node, forwarding the service request from the target node to the source node;
d) receiving at the target node a result of a processing of the service request from the source node; and
e) responding by the target node to the service request with a service request response based on the result received from the source node.

2. The method claimed in claim 1, further comprising the steps of:
f) prior to step a), initiating the data migration from the source to the target node;
g) responsive to step c), processing the service request at the source node and issuing the result.

3. The method claimed in claim 1, wherein the source node is a source Home Location Register (HLR) and the target node is a target HLR of a mobile network, and wherein the reference data comprises records of subscribers of the mobile network that need to be migrated from the source HLR to the target HLR.

4. The method claimed in claim 1, wherein step d) comprises the step of:
f) receiving the service request from an external application.

5. The method claimed in claim 4, wherein the external application comprises a Mobile Switching Center (MSC) of the mobile network.

6. The method claimed in claim 2, wherein step f) comprises the step of:
h) starting a transfer of portions of the reference data from the source node to the target node.

7. The method claimed in claim 6, wherein:
the source node is a source Home Location Register (HLR) of a mobile network;
the target node is a target HLR of the mobile network; and
the portions of reference data comprise subscriber records of subscribers of the mobile network, which subscriber records need to be transferred from the source HLR to the target HLR.

8. The method claimed in claim 2, wherein the step f) comprises the steps of:
h) assigning to the source node a slave status; and
i) assigning to the target node a master status;
wherein the target node having assigned the master status is the node that receives, processes and responds to service requests originating from external applications.

9. The method claimed in claim 1, wherein subsequent to step d), the method further comprises the step of:
f) storing at the target node the result of the processing.

10. The method claimed in claim 9, wherein steps a-f are repeated a plurality of times as triggered by a receipt of each new service request from a plurality of service requests received at the target node, wherein the repeated step f) is used for populating a database of the target node.

11. The method claimed in claim 1, further comprising the steps of:
h) completing a transfer of a certain portion of the reference data to the target node;
i) receiving a new service request at the target node, wherein a processing of the new service request necessitates the certain portion of reference data;
j) forwarding the new service request to the source node;
k) processing the new service request at the target node and issuing a first result of the processing;
I) processing the new service request at the source node and issuing a second result of the processing; and
m) comparing the first result with the second result to determined whether the transfer of the certain portion of reference data was completed successfully.

12. The method claimed in claim 11, further comprising the step of:
n) concluding that the transfer of the certain portion of the reference data to the target node was successful if the first result matches the second result.

13. The method claimed in claim 11, further comprising the step of:
n) concluding that the transfer of the certain portion of the reference data to the target node was unsuccessful if the first result does not match the second result; and
m) transferring again the certain portion of the reference data from the source node to the target node.

14. A system comprising;
a source node from which reference data is to be migrated;
a target node to whom the reference data is to be migrated; and
an external application;
wherein a service request originated from the external application is received at the target node during migration of the data from the source to the target node and responsive to the service request, the target node determines if the reference data necessary to process the service request has been already migrated from the source to the target node, and if not, the target node forwards the service request to the source node, which processes the service request and returns to the target node a result of the processing, and the target node responds to the external application with a service request response based on the result received from the source node.

15. The system of claim 14, wherein the data migration from the source to the target node is initiated prior to the receipt of the service request at the target node.

16. The system of claim 14, wherein the source node is a source Home Location Register (HLR), the target node is a target HLR, the system is a mobile network, and wherein the reference data comprises records of subscribers of the mobile network.

17. The system of claim 14, wherein the external application comprises a Mobile Switching Center (MSC) of the mobile network.

18. The system of claim 14, wherein portions of the reference data are in a process of being transferred from the source node to the target node when the target node receives the service request from the external application.

19. The system of claim 18, wherein:
the system comprises a mobile network;
the source node is a source Home Location Register (HLR) of the mobile network;
the target node is a target HLR of the mobile network; and
the portions of reference data comprise subscriber records of subscribers of the mobile network, which subscriber records are to be transferred from the source node to the target node.

20. The system of claim 15, wherein for initiating the data migration:
the source node is assigned a slave status; and
the target node is assigned a master status;
wherein the target node having assigned the master status is the node that receives, processes and responds to service requests originating from external applications.

21. The system of claim 14, wherein subsequent to the receipt of the result from the source node, the target node stores the result of the processing.

22. The system of claim 14, wherein the target node comprises a database for receiving the migrated reference data from the source node, and uses the result received from the source node for populating the database.

23. The system of claim 14, wherein once a transfer of a certain portion of the reference data to the target node is completed, the target node receives a new service request which processing necessitates the certain portion of reference data, and acts to forward the new service request to the source node, and wherein the new service request is processed at the target node that issues a first result of the processing, and wherein the new service request is also processed at the source node that issues a second result of the processing, and wherein the first result is compared with the second result to determine whether the transfer of the certain portion of the reference data to the target node was successful.

24. The system of claim 23, wherein it is concluded that the transfer of the certain portion of the reference data to the target node was successful if the first result matches the second result.

25. The system of claim 23, wherein it is concluded that the transfer of the certain portion of the reference data to the target node was unsuccessful if the first result does not match the second result, and in such case, the certain portion of the reference data is transferred again from the source node to the target node.

26. A target node to whom the reference data is to be migrated from a source node, which receives a service request originated from an external application during a process of data migration from the source to the target node and, responsive to a receipt of the service request, the target node acts to determine if the reference data necessary to process the service request has been already received from the source and if not, the target node acts to forward the service request to the source node, and in turn receives a result of the processing of the new service request by the source node, and responds to the external application with a service request response based on the result received from the source node.

27. The target node of claim 26, wherein the target node is a target Home Location Register (HLR) of a mobile network, and wherein the reference data comprises records of subscribers of the mobile network that need to be migrated from the source node to the target node.

28. The target node of claim 27, wherein the external application comprises a Mobile Switching Center (MSC) of the mobile network.

29. The target node of claim 27, wherein portions of the reference data are in the process of migration from the source node to the target node when the target node receives the service request from the external application.

30. The target node of claim 26, wherein for initiating the process of data migration:
the target node is assigned a master status;
wherein the target node having assigned the master status is the node that receives, processes and responds to service requests originating from external applications.

31. The target node of claim 26, wherein subsequent to the receipt of the result from the source node, the target node stores the result of the processing.

32. The target node of claim 26, wherein the target node comprises a database for receiving the migrated reference data from the source node, and uses the result received from the source node for populating the database.

33. The target node of claim 26, wherein once a transfer of a certain portion of the reference data to the target node is completed, the target node receives a new service request which processing necessitates the certain portion of reference data, the target node acts to forward the new service request to the source node and to process the new service request to issue a first result of the processing, and wherein the target node also receives a second result of a processing of the new service request performed by the source node, wherein the target node compares the first result with the second result to determine whether the transfer of the certain portion of the reference data was completed successfully.

34. The target node of claim 33, wherein it is concluded that the transfer of the certain portion of the reference data to the target node was successful if the first result matches the second result.

35. The target node of claim 33, wherein it is concluded that the transfer of the certain portion of the reference data to the target node was unsuccessful if the first result does not match the second result, and in such case, the target node requests a new transfer of the certain portion of the reference data from the source node.
